(19) United States
(12) Patent Application Publication
(10) Pub. No.: US 2021/0108543 A1
(43) Pub. Date: Apr. 15, 2021

(54) Electromagnetic Control Device, In Particular for Adjusting Camshafts of an Internal Combustion Engine

(71) Applicant: Kendrion (Villingen) GmbH, Villingen-Schwenningen (DE)

(72) Inventors: Björn Bergfeld, Balingen-Endingen (DE); Holger Brandenburg, Villingen-Schwenningen (DE)

(73) Assignee: Kendrion (Villingen) GmbH, Villingen-Schwenningen (DE)

(21) Appl. No.: 16/603,012

(22) PCT Filed: Mar. 29, 2018
(86) PCT No.: PCT/EP2018/058072

§ 371 Date: Oct. 4, 2019

(30) Foreign Application Priority Data
Apr. 6, 2017 (DE) 10 2017 107 403.1

(51) Int. Cl. F01L 13/00; H01F 7/16

(52) U.S. Cl. CPC F01L 13/0036; F01L 1/047; H01F 7/1607

(57) ABSTRACT

An electromagnetic control device, in particular for adjusting camshafts or a camshaft section of an internal combustion engine, comprising an energisable coil unit, by means of which an armature mounted for movement along a longitudinal axis can be moved relative to a pole core between a retracted position and an extended position; a tappet, which is mounted for movement along the longitudinal axis with a free end portion with which, in the extended position, the tappet interacts with a camshaft in order to adjust the camshaft, and with an inner end portion (30), with which the tappet is attached to the armature, wherein the tappet is attached in a form-fitting manner to the armature by means of a deformable connection element and a method for the form-fitting attachment of a tappet to an armature of an electromagnetic control device of this kind.

The present invention relates to an electromagnetic control device, in particular for adjusting camshafts of an internal combustion engine.

Camshafts comprise a number of cams constituting eccentric sections on the camshaft. The cams can either be disposed fixedly on the camshaft or on camshaft sections that can be applied torsion-proof but axially displaceable on a cylindrical shaft. With the cams adjoiningly disposed, axially displaceable structural parts can be displaced at regular intervals through the rotation of the camshaft. Opening and closing of valves in an internal combustion engine represent specific applications to be noted. In modern internal combustion engines it is feasible to change the engine characteristic from one that is oriented toward convenience to a sporty characteristic. This is implemented inter alia by changing the valve lift which is determined by the shape of the cams. Different engine rotation speeds, furthermore, necessitate variable valve lifts in order to optimize torque and fuel consumption. Other internal combustion engines include a cylinder cut-off, in which some of the cylinders can be deactivated in order to save fuel. In this case the valves of the deactivated cylinders no longer need to be opened. For reasons stated above, it is in this case also of advantage not only to deactivate individual cylinders, but also to enable variable valve lifts.

Such internal combustion engines require camshafts that comprise cams of different sizes and shapes. However, in order to be able to open and close the valve with the different lifting curves, the camshaft or the camshaft section must be axially displaced in order to enable the cooperation of the appropriate cams with the valve. In known control devices for the axial displacement of the camshaft or of the camshaft section, described for example in EP 2 158 596 B1, DE 20 2006 011 904 U1 and WO 2008/014996 A1, the camshafts comprise several grooves into which engages a control device, also referred to as actuator, with a diverse number of tappets. The tappets are herein movable between a retracted and an extended position, wherein in the extended position the tappets engage into the grooving. The grooving represents here a guide section and, together with the engaging tappets, it forms a guide mechanism for the axial adjustment of the camshaft or of the camshaft sections, which must be turned a specific extent for this purpose.

To move the tappets between the retracted and the extended position, the control device comprises an energizable coil unit with which, in the energized state, an armature, mounted movably along a longitudinal axis of the control device, can be moved relative to a [magnetic] pole core. The armature cooperates with the tappet such that the movement of the armature along the longitudinal axis is transferred to the tappet.

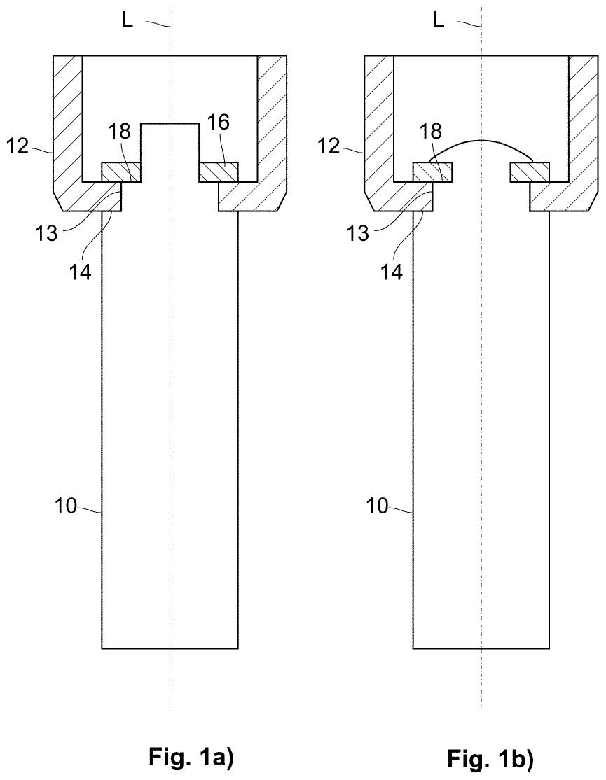

WO 2016/001 254 A1 discloses that the tappet is secured on the armature by using a retaining washer. In Figurers 1a and 1b of the present description the process of producing the connection of the tappet on the armature according to WO 2016/001 254 A1 is described schematically. With reference to the depiction selected in FIGS. 1a and 1 b, the tappet is guided with a direction of movement along a longitudinal axis of the tappet from below through an opening of the armature until the tappet is in contact on a lower ledge on the armature. The retaining washer is subsequently introduced into the armature from above and slid onto the tappet until the retaining washer is in contact on an upper ledge of the tappet. The retaining washer is dimensioned such that it projects radially beyond the opening of the armature. A stamping tool is now introduced from above into the armature and the tappet is deformed such that the retaining washer is secured on the tappet under form closure. Due to the deformation, the tappet assumes a mushroom-like shape. Referred to the longitudinal axis the position of the tappet is now fixed relative to the armature, on the one hand, with the first ledge and, on the other hand, with the retaining washer. A certain play or tolerance can be provided along the longitudinal axis in order, for example, to compensate changes of lengths due to temperature fluctuations.

Of disadvantage in this connection is that the stamping tool must be introduced into the armature and the tappet must undergo relatively severe deformation. Due to the above described [sic] high radial forces acting onto the tappet during operation, the tappet is fabricated of an appropriately high-grade and high-strength steel that can only be deformed with difficulty. Correspondingly high forces are necessary for the deformation which makes it difficult to provide the connection. The tappet is in many cases hardened such that a deformation of the tappet is only possible under high expenditures of force and energy, which is not realizable in series production. However, in order to produce the connection nevertheless, the hardened tappet, at the site at which it is intended to be deformed, is softened again after the hardening in a further thermal treatment process. Apart from the fact that the additional thermal treatment process is time-consuming and incurs additional costs, the strength of the tappet is overall impaired.

An embodiment of the present invention therefore addresses the problem of specifying an electromagnetic control device, in particular for adjusting camshafts of an internal combustion engine, with which the described disadvantages can be counteracted. The control device is in particular intended to be implemented such that the connection between the armature and the tappet can be provided in a simpler and more cost-efficient manner.

This problem is resolved with the characteristics specified in claims 1 and 8. Advantageous embodiments are subject matter of the dependent Claims.

One embodiment of the invention relates to an electromagnetic control device, in particular for adjusting camshafts or a camshaft section of an internal combustion engine, comprising an energizable coil unit with which an armature, mounted movably along a longitudinal axis of the control device, is movable between a retracted position and an extended position, a tappet mounted movably along the longitudinal axis with a free end portion, with which, in the extended position, the tappet, for the adjustment of a camshaft, cooperates with same, and with an inner end portion with which the tappet is secured on the armature, wherein, by means of a deformable connection element, the tappet is secured on the armature under form closure.

In contrast to the manner, described in the introduction, by which according to prior art the tappet is secured on the armature, it is proposed to employ an additional element, specifically the connection element, which is deformed to connect the tappet with the armature.

Consequently, neither the armature nor the tappet has to be deformed in order to form the connection. Since locally limited deformations are extremely difficult to achieve, it is entirely possible in prior art that in particular the tappet becomes distorted during a non-optimal deformation such that it no longer is running ideally [symmetrically] round [about its rotational axis], but rather slightly eccentrically. During operation of the control device this leads to increased wear and increased noise development. Since, according to the proposal, deformation on the tappet or on the armature is not required, the noise development and the wear can be kept to a minimum, whereby the convenience and the service life of the control device are increased.

By deformable connection element is to be understood a connection element that has such low deformation resistance that the connection element can be deformed manually or with a tool, such as pliers or grippers, without a special thermal treatment being necessary for this purpose. The connection element can herein be deformed plastically or elastically. As an elastically deformable connection element, a locking ring, for example a spring-lock washer, can be utilized. It is proposed that the material of the connection element can be freely selected such that the deformation process can be carried out as simply as feasible during the assembly. The material of the connection, moreover, can be selected such that the function of the electromagnetic control device is ensured and in particular the forces occurring during operation are reliably absorbed. The material for the connection element can be metal and, in particular, steel. It has been found to be especially favorable if machining steel, for example of type or grade 11SMn30, is used.

According to a further embodiment, the tappet comprises a first ledge, with which the tappet is in contact on the armature, and a second ledge with which the tappet is in contact on the connection element. In this manner a form closure can be realized simply without the use of additional securement elements. The production process of the proposed control device is hereby kept simple and thus cost-efficient.

In a further embodiment the tappet comprises a [form-fit] recess, extending from the second ledge, into which the connection element can be introduced or is introduced by deformation. Once the connection element is introduced into the recess, its position is fixed relative to the tappet such that no further measures need to be taken to achieve this purpose. The production process of the proposed control device is hereby kept simple and thus cost-efficient.

In a further developed embodiment the connection element can be developed as a deformable ferrule. In this embodiment commercially available connection elements, and thus elements available in many sizes and at low cost, can be drawn on such that one-off productions can be avoided. In particular, crimp ferrules can be utilized as connection elements that can be deformed appropriately with crimping tools that are also available. Consequently, there is no need for special tools to be manufactured such that the production process can be further simplified and made cost-efficient.

In a further developed embodiment the tappet can include a third ledge with which the tappet is in contact on the ferrule. The ferrule can be simply slid onto the tappet during the assembly until it is in contact on the third ledge. The ferrule is hereby at least prepositioned such that no further measures need to be taken to achieve such. This accelerates and simplifies the assembly.

In a further embodiment the ferrule can comprise a deformation section. The manner in which the ferrule is to be deformed can be affected through the deformation section. For example, the deformation section can be realized by means of reduction of the wall thickness. It is hereby attained that even if the tool utilized for the deformation does not, as intended, engage on the ferrule, the ferrule is still, as desired, deformed. By providing the deformation section, the force necessary for the deformation can, furthermore, still be reduced as intended, which simplifies the forming process.

A further developed embodiment is distinguished thereby that the tappet is hardened throughout. As stated in the introduction, during operation of the control device high forces are exerted onto the tappet. The tappets in prior art are hardened. However, in this case that means they cannot be formed at all or only using unjustifiable expenditures, as shown in FIG. 1a or 1 b. For that reason, in the region in which they are to be formed, the tappets are subjected to a further thermal treatment such that they are softer in this region and thus formable. This complicates the production process and the strength of the tappet is reduced. Since, as proposed, it is no longer necessary to form the tappet in order to secure it on the armature, the feasibility is obtained of employing a tappet hardened throughout or completely. Any further thermal treatment can be omitted. Moreover, strength is retained throughout over the entire tappet.

In a further embodiment the tappet is rotatably secured on the armature. In this embodiment a [friction-abrasion] wear location is formed between the connection element and the armature. The material of the connection element can be selected such that wear is kept to a minimum or is substantially limited to the connection element. As stated previously, the tappet is rotated during its engagement into the grooving of the camshaft. If the securement of the tappet on the armature were non-rotatable, the armature would rotate together with the tappet during operation. The armature is conventionally prestressed by means of a spring element such that the rotation would be transferred to the spring element. This could lead to an increased loading of the spring element or even to the destruction of the spring element especially because the spring element can be coiled up. Furthermore, the spring element and the armature would be exposed to increased wear at the contact site. By supporting the tappet rotatably on the armature, the armature and the spring element are decoupled from the tappet and consequently are not subjected to the above described loading.

One embodiment of the invention relates to a method for the form-fit securement of a tappet on an armature of an electromagnetic control device according to one of the previous embodiments, comprising the following steps:
providing a deformable connection element, and
connecting the tappet on the armature under form-locking connection by deformation of the connection element.

The technical effects and advantages obtainable with the proposed method correspond to those that have been discussed for the present control device. In summary, it is pointed out that, in contrast to the manner in which the tappet is secured on the armature in prior art described in the introduction, it is proposed to utilize an additional element, specifically the connection element, which is deformed to yield the connection of the tappet with the armature. As a consequence, neither the armature nor the tappet has to be deformed for the purpose of forming the connection. Since it is extremely difficult to achieve locally limited deformations, it is entirely possible in prior art for the tappet in particular to become distorted in the event the deformation is not carried out optimally. This leads to the tappet no longer running ideally [symmetrically] round [about its rotational axis], but rather slightly eccentrically. The result is increased wear during operation of the control device and increased noise development. Since, as proposed, no deformation is required on the tappet or on the armature, the noise development and the wear can be kept to a minimum, whereby the convenience and service life of the control device are increased.

According to a further developed embodiment of the method, in which the tappet comprises a first ledge and a second ledge as well as a [form-fit] recess extending from the second ledge, the method comprises the following steps:
positioning the tappet such that the tappet is in contact on the first ledge, and
introducing the connection element into the recess by deforming the connection element.

In this embodiment of the method the tappet can be secured simply and yet precisely on the armature. The production process of the proposed control device is hereby kept simple and thus cost-efficient.

Exemplary embodiments of the invention will be described in further detail in the following with reference to the attached drawing. Therein depict:

FIGS. 1a and 1 b a schematic representation of the manner in which in prior art a tappet is connected with an armature,

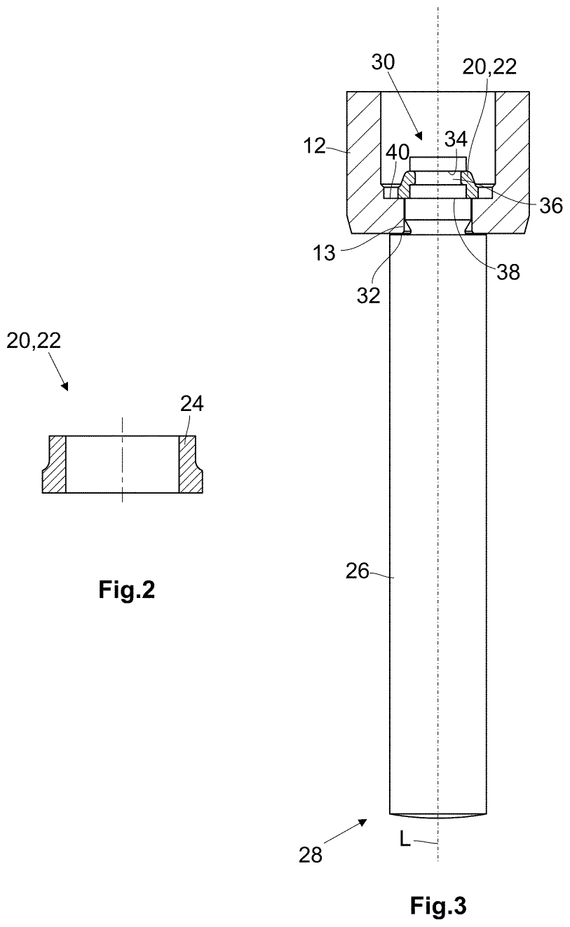

FIG. 2 a sectional representation of an embodiment example of a connection element,

FIG. 3 a sectional representation of a tappet connected with the armature by the connection element depicted in FIG. 2,

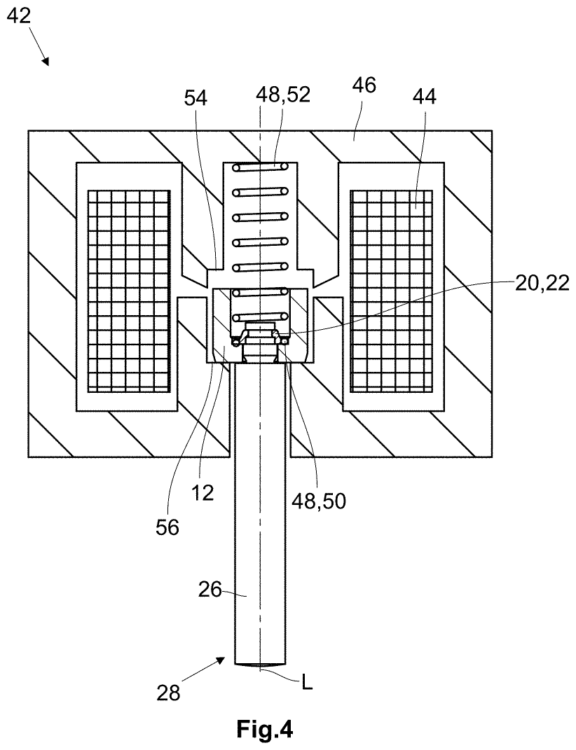

FIG. 4 a basic sectional representation of an electromagnetic control device in which the tappet is connected to the armature by a connection element depicted in FIG. 2.

FIGS. 1a and 1 b show schematically the manner by which in prior art a tappet 10 is connected with an armature 12. With reference to the depiction selected in FIGS. 1a and 1 b, the tappet 10 is guided from below with a movement directed along a longitudinal axis L of tappet 10 through an opening 13 of the armature 12 until the tappet 10 with a lower ledge 14 is in contact on the armature 12. A retaining washer 16 is subsequently introduced from above into the armature 12 and slid onto the tappet 10 until the retaining washer 16 is in contact on an upper ledge 18 of tappet 10. The retaining washer 16 is dimensioned such that it projects radially beyond the opening 13 of armature 12. Subsequently, a not depicted stamping tool is introduced from above into armature 12 and tappet 10 is deformed such that the retaining washer 16 is secured on the tappet 10 under form closure. Due to the deformation, tappet 10 assumes a mushroom-like shape. The position of tappet 10 is now fixed with respect to the longitudinal axis L with the lower ledge 14 and, on the other hand, with the retaining washer 16. A certain play or tolerance along the longitudinal axis L can herein be provided for the purpose, for example, of compensating longitudinal changes due to temperature fluctuations.

FIG. 2 shows an embodiment example of a proposed connection element 20 with reference to a sectional representation. The connection element 20 is implemented as a tubular ferrule 22 comprising a deformation section 24. In the deformation section 24 the ferrule 22 has a reduced wall thickness.

FIG. 3 shows a sectional representation of a proposed tappet 26 connected to the armature 12 by the connection element 20 depicted in FIG. 2. Armature 12 is structured precisely as the armature 12 shown in FIGS. 1a and 1 b. Graphical discrepancies should be ignored. The tappet 26 comprises a free end portion 28 and an inner end portion 30, wherein within the inner end portion 30 the tappet 26 comprises a first ledge 32, a second ledge 34, a recess 36 extending from the second ledge 34, and a third ledge 38.

Again, with reference to the representation selected in FIG. 3, the tappet 26 is guided from below, with a movement directed along the longitudinal axis L of the tappet 26, with the inner end portion 30 through opening 13 of armature 12 until the tappet 26 is in contact with the first ledge 32 on armature 12. Ferrule 22 is subsequently slid onto tappet 26 until ferrule 22 is in contact on the third ledge 38 of tappet 26. The third ledge 38 is disposed such that it is flush with a bottom face 40 of armature 12 or projects minimally beyond the bottom face 40 when tappet 26 is in contact with the first ledge 32 on armature 12. A not depicted tool is subsequently slid [into the armature 12] from above onto ferrule 22. The tool can be implemented such that it is in contact at the transition from the deformation section 24, or from the reduced wall thickness, to the full wall thickness of ferrule 22. A positioning of the tool is thereby achieved. Ferrule 22 is subsequently deformed using the tool such that ferrule 22 is introduced into the recess 36, as is shown in FIG. 3. The position of ferrule 22 on tappet 26 is now fixed. The tool is subsequently retracted from the armature 12. Tappet 26 is now secured on armature 12 under form closure.

FIG. 4 shows a basic sectional representation of an electromagnetic control device 42 in which the tappet 26 is connected on armature 12 by the connection element 20 depicted in FIG. 2. Only those components are depicted that are required for an understanding of the function of the control device 42.

In a manner not further shown, tappet 26 is mounted in the control device 42 such that it is displaceable along its longitudinal axis L, for which purpose a slide bearing of synthetic material or a not magnetizable material can be employed.

To move the armature 12, the control device 42 comprises a coil unit 44 which annularly encompasses armature 12 with the formation of a gap. The control device 42 comprises furthermore a magnet unit 46 which comprises a pole core and a permanent magnet that are not explicitly shown and are considered to be included in the depiction of magnet unit 46.

Beyond that, there is provided a spring element 48 with a first end 50 and a second end 52. The spring element 48 can provide a prestress force acting substantially along the longitudinal axis L. The spring element 48 is stayed with the first end 50 on the bottom face 40 (see FIG. 3) and with its second end 52 on the magnet unit 46.

The control device 42 is operated in the following manner: the not depicted permanent magnet exerts an attractive force onto armature 12 acting along the longitudinal axis L, such that, in the retracted state, armature 12 is attracted by the permanent magnet and is in contact on an upper stop 54. The spring element 48 is hereby compressed such that spring element 48 provides a prestress force that is, however, less than the force of attraction of the permanent magnet. Armature 12 and tappet 26 consequently assume a retracted position that is not shown.

If the coil unit 44 is now energized, a magnetic field is built up that induces a magnetic force onto armature 12 which acts in the same direction as the prestress force provided by spring element 48 and consequently acts against the force of attraction of the permanent magnet. The sum of the magnetic force of the permanent magnet and the prestress force is greater than the force of attraction of the permanent magnet such that armature 12, and consequently also tappet 26, is moved away from the permanent magnet along the longitudinal axis L until armature 12 abuts against a lower stop 56 whereby tappet 26 and armature 12 have reached the extended position depicted in FIG. 4. In this extended position tappet 26 engages with its free end portion 28 into a grooving of a not depicted camshaft section. Referred to the rotational axis of the camshaft, the grooving has a spiral or helical course such that the engagement of tappet 26 into the grooving in combination with the rotation of the camshaft about its own rotational axis effects a longitudinal displacement along the rotational axis of the camshaft. To transfer appropriate axial forces, tappet 26 is in contact on one of the side walls of the grooving and rolls out on its surface such that tappet 26 at the engagement into the grooving is rotated at a very high rotational speed. The depth of the grooving decreases toward the end such that, starting at a certain angle of rotation of the camshaft, a tangency of the free end portion 28 of tappet 26 with the base of the grooving is carried out whereby tappet 26 is moved again in the direction of the permanent magnet. At this point at the latest the energization of the coil unit 44 is interrupted such that the force of attraction exerted by the permanent magnet onto armature 12 is again greater than the sum of the prestress force provided by the spring element 48, and of the magnetic force that is no longer active due to the absent energization of coil unit 44.

Tappet 26 and armature 12 consequently assume again the retracted position until the coil unit 44 is again energized. Further description of the function of the control device can also be found in WO 2016/001 254 A1.

As has been explained, when engaging into the grooving of the camshaft, tappet 26 is rotated about the longitudinal axis L. However, since the tappet 26 is mounted rotatably on armature 12, the rotation is not transferred onto armature 12 and consequently also not onto spring element 48. With reference to the rotation, tappet 26 is therefore decoupled from armature 12 and spring element 48.

### LIST OF REFERENCE SYMBOLS

10 Tappet according to prior art
12 Armature
13 Opening
14 Lower ledge
16 Retaining washer
18 Upper ledge
20 Connection element
22 Ferrule
24 Deformation section
26 Tappet
28 Free end portion
30 Inner end portion
32 First ledge
34 Second ledge
36 Recess [form-fit]
38 Third ledge
40 Bottom face
42 Control device
44 Coil unit
46 Magnet unit
48 Spring element
50 First end
52 Second end
54 Upper stop
56 Lower stop
L Longitudinal axis

1. An electromagnetic control device, comprising:
an energizable coil unit,
an armature, which is mounted displaceably along a longitudinal axis and is movable between a retracted position and an extended position,
a tappet mounted movably along the longitudinal axis, comprising:
a free end portion with which the tappet, in an extended position cooperates with a camshaft to adjust the camshaft and
an inner end portion, with which the tappet is secured on the armature,
a deformable connection element,
wherein the tappet is secured on the armature under form closure with the deformable connection element.

2. The electromagnetic control device of claim 1, wherein the tappet comprises:
a first ledge with which the tappet is in contact on the armature, and
a second ledge, with which the tappet is in contact on the connection element.

3. The electromagnetic control device of claim 2, wherein the tappet comprises a form-fit recess, extending from the second ledge, into which the connection element is introducible by deformation.

4. The electromagnetic control device of claim 1, wherein the connection element is a deformable ferrule.

5. The electromagnetic control device of claim 4, wherein the tappet comprises a third ledge with which the tappet is in contact on the ferrule.

6. The electromagnetic control device of claim 4, wherein the ferrule comprises a deformation section.

7. The electromagnetic control device of claim 1, wherein the tappet is hardened.

8. The electromagnetic device of claim 1, wherein the tappet is rotatably secured on the armature.

9. A method for securing a tappet on an armature of the electromagnetic control device of claim 1, comprising the following steps:
providing the deformable connection element and connecting the tappet on the armature under form closure by deformation of the connection element.

10. The method of claim 9, wherein the tappet comprises a first ledge and a second ledge as well as a form-fit recess extending from the second ledge, comprising the following steps:
positioning the tappet such that the tappet is in contact on the first ledge, and
introducing the connection element into the recess by deformation of the connection element.
